(19) United States
(12) Patent Application Publication
(10) Pub. No.: US 2015/0354958 A1
(43) Pub. Date: Dec. 10, 2015

(54) THE CALCULATION METHOD REQUIRING A ROTARY INFORMATION, THE ROTATIONAL CALCULATION PROGRAM THE MAGNETIC GYROSCOPE AND THE MOBILE DEVICE

(71) Applicant: MAGNEDESIGN CORPORATION, Chita-gun, Aichi (JP)

(72) Inventor: Yoshinobu HONKURA, Chita-gun (JP)

(21) Appl. No.: 14/763,619

(22) PCT Filed: Jan. 24, 2014
(86) PCT No.: PCT/JP2014/051562

§ 371 Date: Jul. 27, 2015

(30) Foreign Application Priority Data
Jan. 25, 2013 (JP) 2013-012697

(51) Int. Cl. G01C 19/32; G01B 7/30; G01D 5/12

(52) U.S. Cl. CPC G01C 19/32; G01D 5/12; G01B 7/30

(57) ABSTRACT

A rotary information computation method eliminate measurement lag of a magnetic gyroscope. This method determines the angular velocity vector of a moving body divided into the magnitude and direction (rotation axis vector) thereof. The method for computing the rotation axis vector is altered depending on whether the rotational mode of the moving body is a stationary axis rotational mode or a free axis rotational mode. If in stationary axis rotational mode, the rotation axis vector is determined by the outer product of two difference vectors. If in free axis rotational mode, the determination is made by calculating the outer product of a difference vector and a radius vector on the basis of a set instantaneous rotational coordinate system. At such time, the rotation axis vector (ni−1) calculated at a time (ti−1) is used (i.e, as feedback) to compute the rotation axis vector (ni) at the following time (=ti−1+Δt).

### TECHNICAL FIELD

The present invention relates to the calculation method requiring a rotary information such as the angular velocity, rotation angle and so on of the moving body as the mobile computer to be variable in attitude using the standard magnetic field as the earth magnetic field. Moreover the present invention relates to the rotational calculation program carrying out the calculation method, the magnetic gyroscope equipping the program and the mobile device equipping the magnetic gyroscope.

### BACKGROUND ART

The calculation methods requiring a rotary information of the moving body which are the attitude (directions, orientation, tilt and so on), the precise change speed on time and so on are strongly requested from the market not only for the aircraft, ship, automobile and so on but also for computer terminals such as mobile phones and smart phones, the positioning mobile terminals such as car navigation and electronics devices such as digital camera and so on.

The vibration type Gyroscope is well known as the sensor to detect the angular velocity. The MEMS type gyro sensors of small size achieved by the Micro Electro Mechanical System technology are widely used in the mobile terminal devices. The principle of the MEMS type gyro sensor is based on the Coriolis force (2 mvω) which is forced to the vibrator of the mass (m) having the velocity (v) in resonance under the rotation with the angular velocity (ω). The vibrator is produced to form combo teethes on the Silicon substrate. The capacitance with combo teethes changes according to the Coriolis force so that and can be calculated on time. When integrating the angular velocity, the angular angle and the attitude of the moving body can be obtained.

However the MEMS type gyro sensors are expensive compared to both of magnetometers and accelerometers which are assembled together in the mobile terminal devices. They take big energy consumption because the continuous vibration of the vibrator is needed for measuring the angular velocity. Moreover they cannot give precise angular velocity once in a while because the vibrators are affected by the vibration and impaction other than the rotation.

The development of the method using magnetometers alternative to the MEMS gyro sensor for measuring the angular velocity have been challenged to achieve the small size, low energy consumption, low cost and improvement of measurement precision on the attitude of the gyro sensors used in the mobile terminal devices.

### CITATION LIST

### Patent Literature

### [PTL 1]

### WO 2007/099599A1

### SUMMARY OF INVENTION

### Technical Problem

The literature 1 proposed the magnetic Gyroscope to calculate the angular velocity vector consisting of the rotational rotation axis vector and the angular velocity around the rotation axis using more than 3 points of the earth magnetic field vector measured by a magnetometer with the Cartesian coordination system equipped on the moving body. The magnetic gyroscope makes possible to obtain the rotary information without MEMS gyro sensor.

The magnetic gyroscope described in literature 1 needs three magnetic field vector measured before the time calculating the angular velocity at the moment which means to give the average angular velocity during the measuring interval. Moreover for improving the measurement accuracy, the area of the fanning formed with tree points is needed to keep large enough. In other words, the interval of the sampling time is necessary to be long. It is difficult to make the quick response following to the change of the moving body due to the long time needed before calculation. The magnetic gyroscope described in literature 1 has the response delay of from 100 ms to 200 ms compared to that of MEMS gyro sensor. In general the screen of the mobile phone changes per about 16 ms, so that the delay time of more than 100 ms must be serious problem. It is important to suppress the delay time under 16 ms for making practical applications of the magnetic gyroscope.

The present invention has been achieved to solve the above technological problems. The purpose of the present invention is to offer the calculation method quickly requiring a rotary information of the various movable devices based on the magnetic information measured by magnetometer, the rotational calculation program carrying out the calculation method, the magnetic gyroscope equipping the program and the mobile device equipping the magnetic gyroscope.

### Solution to Problem

After researching to solve these above problems in earnest and making a lot of try and errors, the inventor found a new algorism idea to achieve “the calculation method requiring the rotary information” can calculate the angular velocity at the moment using two magnetic field vector measured at the two measuring time instead of the current way needed for 3 measuring time. Extending the result, the present invention has been reached to completion.

### <<The Calculation Method Requiring a Rotary Information>>

(1) The calculation method requiring a rotary information of the present invention can obtain the real angular velocity vector (ωₜₕ) of a moving body which is calculated by the program consisting of a step to measure 3 dimensional vector components of standard magnetic field vector keeping stable in the magnitude (strength) and direction per a very small time continuously, second step to require an virtual angular velocity vector (ωₚᵣ) using the outer product (Hᵢ×ΔHᵢ) with a (i)th magnetic field vector and a difference magnetic vector (ΔHᵢ=Hᵢ−Hᵢ₋₁) between the (i)th magnetic field vector (Hᵢ) measured at the (i)th time and the (i−1)th one (Hᵢ₋₁) at the (i−1)th time before a very small time from (i)th time, the third step to give the real rotation axis vector (n) at the (i)th time, the fourth step to calculate a differential angle (αᵢ) or the differential angle index between the (i)th magnetic field vector (Hᵢ) and the real rotation axis vector (n) and the fifth step to require the real angular velocity vector (ωₜₕ) using the absolute value of virtual angular velocity vector (ωₚᵣ), the differential angle index and the real rotation axis vector (n).
(2) The calculation method requiring a rotary information of the present invention can calculate the absolute value (|ωₜₕ|) and the rotation axis vector (n) separately. The absolute value (|ωₜₕ|) is calculated by the virtual angular velocity (ωₚᵣ) and the angle index between the rotation axis and the magnetic field vector. The rotation axis vector (n) is calculated exactly according to the rotational mode of the moving body. As the result, the exact rotary information is given with almost no delay even when the rotation axis of the moving body is changing under rotation.

When the moving body is rotating with a stationary axis mode to rotate around a constant specified axis, the third step is favorable to give the real rotation axis vector (n_{Δ}) at the (i)th time which is calculated by the outer product (ΔHᵢ₋₁×ΔHᵢ) of the difference vector (ΔHᵢ₋₁=ΔHᵢ₋₁−ΔHᵢ₋₂) between the (i−1)th magnetic field vector (Hᵢ₋₁) measured at the (i−1)th time and the (i−2)th magnetic field vector (Hᵢ₋₂) at the (i−2)th time before a micro time from (i−1)th time, and the difference vector (\dot{Δ}Hᵢ).

When the moving body is rotating with a free axis rotational mode to rotate around a changing axis vector the third step is favorable to give the real rotation axis vector (nᵢ) at the (i)th time which is calculated by three vectors of the (i)th magnetic field vector (Hᵢ), the difference vector (ΔHᵢ=Hᵢ−Hᵢ₋₁) between the (i)th magnetic field vector (Hᵢ) measured at the (i)th time and the (i−1)th magnetic field vector (Hᵢ₋₁) at the (i−1)th time before a very small time from the (i)th time, and the moving radius vector (Hr) from rotation origin (O*) to the (i)th magnetic field vector (Hᵢ) where the origin is defined by three vectors of the real rotation axis vector (nᵢ₋₁) at the (i−1)th time, the (i)th magnetic field vector (Hᵢ) and the (i−1)th magnetic field vector (Hᵢ₋₁). The feedback calculation assumed the rotation axis (nᵢ₋₁) at the (i−1)th time would be regarded as the rotation axis (nᵢ) at the ith time, can give the real rotation axis (nᵢ) at the (i)th time with exact and no delay.

### <<Magnetic Gyroscope>>

(1) The present invention is not only the calculation method but also the rotational calculation program which can carry out the calculation method by computer to require a rotary information, memory the result into memory equipment and communicate with outside computer systems.

It should be noted that the present invention is the computer to equip the memory media such as ROM (Read Only Memory) or RAM (Random Access Memory) holding the above rotational calculation program in the case the program is not approved as an object.

(2) The present invention is also a magnetic gyroscope to output the rotary information on the changing attitude of the moving body which consists of a magnetometer to measure the three dimensional magnetic field keeping the absolute value and the direction steady, a memory equipment to store the rotational calculation program described in claim 13 and the calculation equipment to carry out the rotational calculation program.

The magnetic gyroscope to equip an accelerometer to measure 3 dimensional acceleration including the gravity acceleration is favorable because it can calculate the rotary information exactly under various rotational modes. It should be noted that the memory or arithmetic devices which are equipped to the gyroscope for exclusive use or existed in the moving devices for general use can be used.

(3) Moreover, the present invention is the moving body equipping the magnetic gyroscope described above. The moving body that becomes the object of the present invention are measuring modules or devices to measure the attitude, directions, orientation and so on and electronics devices including these measuring devices.

### <<Others>>

(1) The step as the constitution of the present invention is equivalent to the mean, which suggests that constitution of the calculation method requiring a rotary information of the present invention is equivalent to that of the rotational calculation program of the present invention in fact.

The rotary information of the present invention defined as the index information on the motion state or the result accompanied by the rotation of the moving body is sufficient as long as it is based on the real angular velocity vector. The rotary information may include the rotation angle calculated by the integration of the rotation velocity vector and the rotation axis in addition to the angular velocity vector. The rotary information to relate to the present invention may include only any side of the absolute value and the direction which is given by the angular rotation vector.

The coordinates to relate to the present invention which are three types of the sensor system, the earth system, and the rotation system are sufficient as long as they define three independent vector components of the magnetic field vectors and its difference vectors changing according to the rotation of the moving body. That is, the coordinates to relate to the present invention is not limited to the three-dimensional orthogonal coordinates as Cartesian coordinate.

(2) The standard magnetic field vector described in the present description is sufficient as long as the magnetic field vector changed by the rotation of the moving body is detected steadily. The typical one is the earth magnetism. The primary or the secondary described in the present description is convenient in expression not given the specified time or vector. The micro time (Δt) described in the present description becomes smaller, the accuracy becomes better but the load to arithmetic unit becomes bigger. As a result, it is favorable to be 3 ms to 8 ms.
(3) In the present description, the expression of the vector is not accompanied with the arrow on the alphabetical letter or the bold faced letter owing to the limitation of expression. That is, the vector is expressed simply by the alphabetical letter. The index of “i” is a pulse integer. The smaller index expresses the latter time except special comment. The index of “i” means the present time, and that of “i−1”, “i−2” in turn means the past time by the micro small time of Δt. By the way, any very small time of Δt is allowed not to be constant. The very small time which is conveniently expressed by Δt or Δtᵢ takes different value according to real applications but of course may take constant.

The expression of “x to y” includes the minimum value of x and the maximum value of y except special comment. Any numerical value included in various numerical value or range described in the present description can use as the minimum value of a and the maximum value of b for making new numerical value range of “a to b”. It should be noted that the range can exist if it has one side as the minimum value or the maximum value.

### BRIEF DESCRIPTION OF DRAWINGS

FIG. 1A is the schematics figure showing the motion situation using three magnetic field vector (H₁, H₂, H₃) measured at three different times under the rotation.

FIG. 1B is the enlarged figure of the important part in FIG. 1.

FIG. 2A is the schematics figure showing the motion situation using two magnetic field vector (Hᵢ, Hᵢ₋₁) measured at two different times under the rotation.

FIG. 2B is the enlarged figure of the important part in FIG. 2.

FIG. 2C is the unit vector (eₙ′, eᵥ′, eᵣ′) using calculation of the rotation under the rotation with free axis rotational mode.

FIG. 3 is the schematics figure showing the orbit axis rotational mode in the rotation axis vector space.

FIG. 4 is the explanation figure showing the relationship between the difference vector and the angular velocity (ω) which are used to judge the reversal mode.

FIG. 5 is the flow chart showing embodiment 1 to relate to the calculation method.

FIG. 6A is the graph showing the example to calculate the angular velocity vector (ωₓ, ω_{y}, ω_{z}) under the rotational mode with the constant rotation axis vector compared to that of current Gyro sensor.

FIG. 6B is the graph showing the example to calculate the angular velocity vector (ωₓ, ω_{y}, ω_{z}) under the orbit axis rotational mode compared to that of current Gyro sensor.

FIG. 6C is the graph showing the example to calculate the angular velocity vector (ωₓ, ω_{y}, ω_{z}) under the free-axis rotational mode compared to that of current Gyro sensor.

### DESCRIPTION OF EMBODIMENTS

The technical content explained in the present description is applied to the rotational calculation program, the magnetic gyroscope and the mobile device as well as the calculation method requiring the rotation. The constitution of the calculation method is equivalent to that of the object such as the program, the gyroscope and the mobile devices because the step can be regarded as the means. The present inventions are affective even if one or more than two constitutions picked out from any constitution in the present description would be added to the constitutions of the present invention described above. Which embodiment is the best or not is depend on the applications or requested specifications.

### <<Algorism>>

The calculation method requiring the rotation of the present invention can be achieved by carrying out repeatedly the calculation described below and can give the real angular velocity vector (ω_{if}) in real time which is needed to obtain the momentary attitude of the moving body.

### <<Outline>>

(1) The momentary angular velocity vector during micro time Δt of the rotating body (material particle) can be calculated as the angular velocity vector ω_{Δ} parallel to the rotation axis vector by the physics equation shown in equation of 1A. The size of the angular velocity vector is calculated as the absolute value and the rotation axis is calculated as the unit vector (n_{Δ}) obtained by normalizing the angular velocity vector by the equation shown in the equation of 1B.

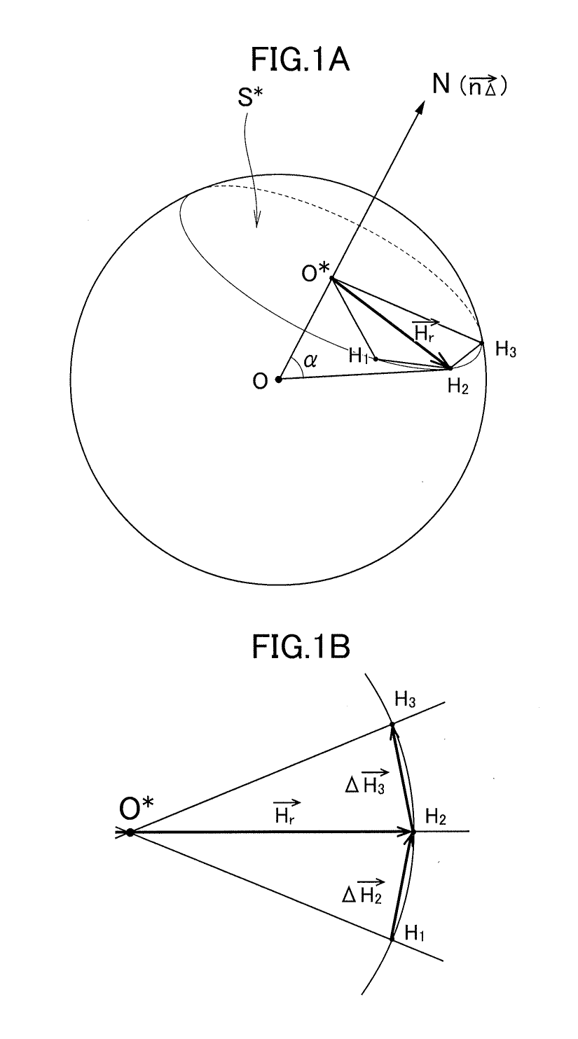

In order to calculate the angular velocity vector using the equation of 1A, it is needed that three magnetic field vectors (H₁, H₂, H₃) existing on the orbit of the rotation shown in FIG. 1A are measured and the two difference vector of ΔH₂(=H₂−H₁) and ΔH₃(=H₃−H₂) in FIG. 1B is prepared.

The calculation method needs at least three points. Moreover the interval to measure three magnetic field vector should be made to become long for keeping high accuracy. The calculation using the equation of 1A which is effective under the rotation with constant rotation axis vector including the initial period of the rotation and the method cannot follow up the rapid attitude change of the moving body.

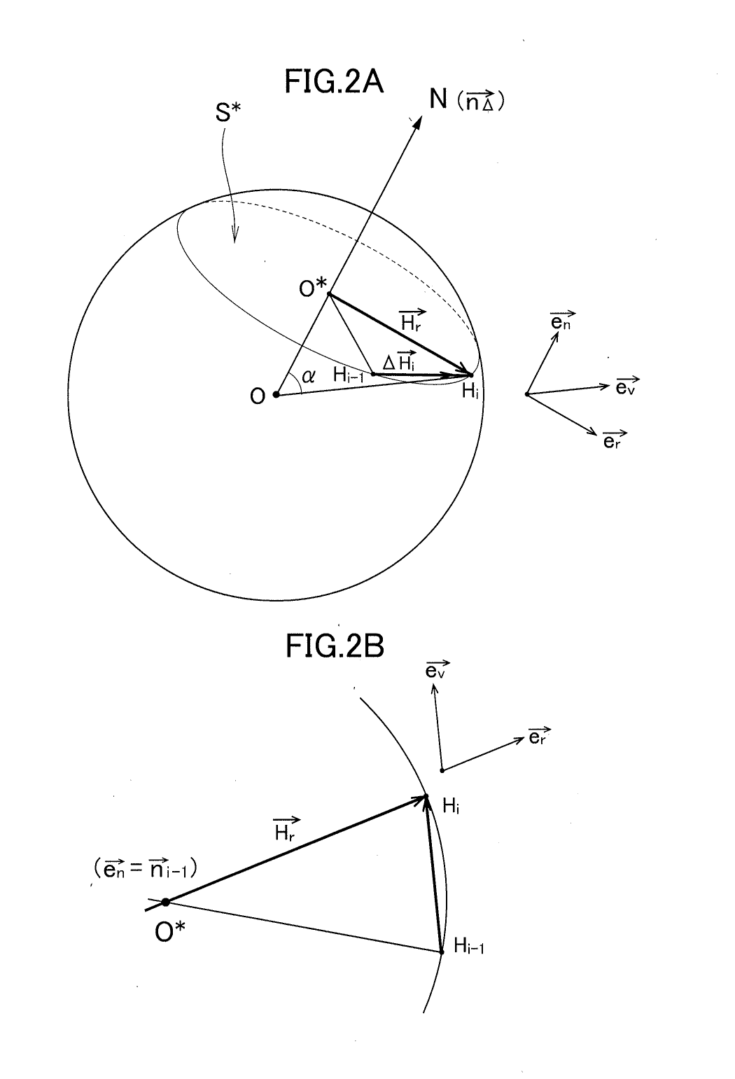

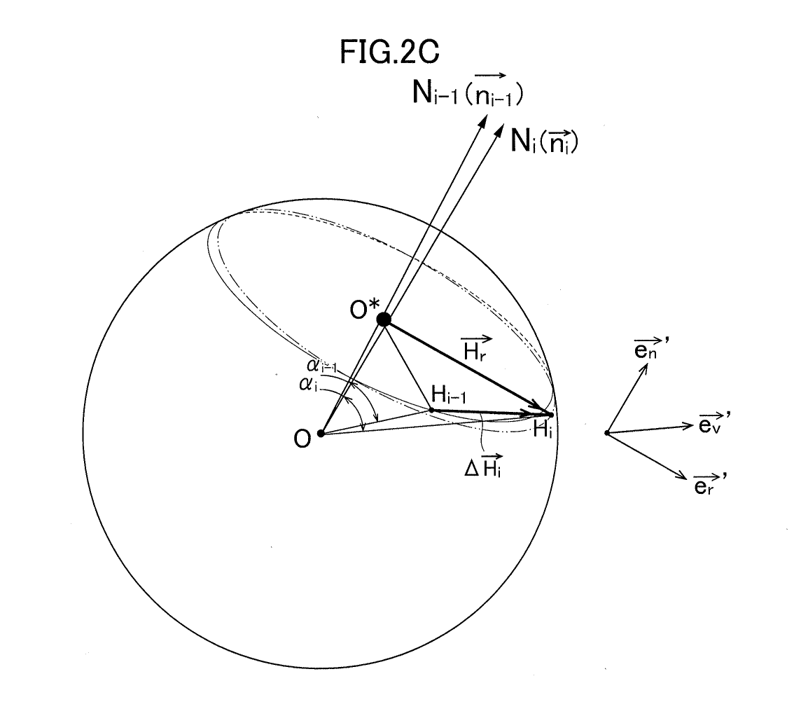

(2) Supposing the momentary rotation center is given, anther calculation on the momentary angular velocity vector using another physics equation 2 different in expression instead of the equation 1A is considered. This equation is carried out not using three points described above but using two magnetic field vector (Hᵢ, Hᵢ₋₁) measured at the momentary time of (i)th and just before time of (i−1)th expressed in FIG. 2A and FIG. 2B, where the momentary time of (i)th is defined as tᵢ=t₀+Δt·i and t₀ is the starting time in measurement. Therefore it can give the momentary angular velocity vector even though the attitude of the moving body is changed rapidly.

That is, if the rotation center is given, the radius vector Hr toward from the center (O*) to the magnetic field vector Hᵢ is obtained shown in FIG. 2A and FIG. 2B as well as the equation 2 and the momentary angular velocity vector ωₜₕ is calculated using the radius vector Hr and the difference vector ΔHᵢ. However it is very difficult to obtain the radius vector Hr directly. To solve the problem, the present invention makes the rotation to classification of two modes which are a stationary-axis mode to rotate with a constant or stable rotation axis vector and a free-axis rotational mode to rotate with changing rotation axis vector and carried out the calculation to obtain the momentary angular velocity vector.

It is noted that the change or shift of the rotational mode must be made smoothly because the rotation axis vector is not change rapidly due to the angular momentum conservation law. When the rotation mode is changed, the starting angular velocity vector under the new mode is connecting by the equal value with the last value under before mode so that the calculation result with high accuracy is kept stably and consecutively. For example, it is considered that the starting value under a free-axis rotational mode is given by the angular velocity vector ωₜₕ calculated under a stationary-axis mode just before the mode changes.

<Rotational Mode with the Stationary Rotation Axis Vector>

The rotational mode with the constant rotation axis vector is the case to keep the rotation axis vector practically with no change. In this case, the rotation axis vector n_{Δ} is specified by calculation using the equation of 1A and 1B.

Moreover it is necessary that the magnitude of the real angular velocity vector ωₜₕ is calculated for specifying the real angular velocity vector. The virtual angular velocity vector ωₚᵣ is defined using the equation 3. This vector ωₚᵣ is different from the real angular velocity vector but there is the relationship between the both vectors of |ωₚᵣ| and |ωₜₕ| on the magnitude shown in the equation 4, where the angle αᵢ of the equation 4 is the angle ∠O*OHᵢ between the rotation axis vector n_{Δ} and the magnetic field vector Hᵢ.

By the way, it is proved the equation 4 is completed by means of the following discussion. The magnetic field vector Hᵢ moves by the distance calculated by multiplying angular velocity ω, the radius and the interval time during a very small interval Δt, so that the relation of |ωₜₕ|·Δt·|Hr|=|ωₚᵣ|·Δt·|Hᵢ| is formed. And the relation of |Hr|=|Hᵢ| sin αᵢ is derived from the right triangle OO*Hᵢ shown in FIG. 2A. From both relationships, the equation of |ωₜₕ|=|ωₚᵣ|/sin αᵢ as shown in equation 4 is derived.

The angel αᵢ is the angle between the rotation axis vector n_{Δ} and the magnetic field vector Hᵢ. Therefore the value of sin αᵢ is calculated by the value of cos αᵢ derived by the inner product (h·n_{Δ}) of both vectors.

In this manner, the present invention calculates the virtual angular velocity vector ωₚᵣ using the outer product of the magnetic field vector Hᵢ and the difference vector (ΔHᵢ=Hᵢ·Hᵢ₋₁) which is the difference between the magnetic field vector Hᵢ and the just before magnetic field vector Hᵢ₋₁. Finally using the absolute value of ωₚ sin αᵢ and n_{Δ} which is calculated by the equations of 1A and 1B, the real angular velocity vector ωₜₕ is derived by the equation 5 (In this manner, the step to calculate the real angular velocity vector is decided.).

### <Free Axis Rotational Mode>

The free-axis rotational mode is the mode to rotate with changing rotation axis vector. In this case, the equation 2 mentioned above is used in the same way as the base equation for obtaining the real rotation axis vector Hᵢ at any momentary time tᵢ. It is difficult to obtain the radius vector Hr directly as same as the case of the rotational mode with the constant rotation axis vector so that the free-axis rotational mode requests to calculate the angular velocity vector using the equation 2 where the absolute value and the orientation are separately used.

First of all, the absolute value of the angular velocity vector ωₜₕ is given as the parameter of |ωₚᵣ|/|sin αᵢ| described below using ωₚᵣ and sin αᵢ calculated by both equations of 3 and 4.

Next, the angular axis vector nᵢ of the angular velocity vector ωₜₕ is calculated by the equation 2. The momentary three axis rectangular coordinate system is defined as the rotation coordinate system assuming the rotation axis vector nᵢ and the angel αᵢ₋₁ at the (i)th time are equal to that at the (i−1)th time. The system consists of three unit vector of eₙ, eᵥ, eᵣ where eₙ is supposed as eₙ=nᵢ₋₁, eᵣ is derived as the normalized value given from both vector of eₙ and h(=Hᵢ/|Hᵢ|) and eᵥ is the outer product of eₙ and eᵣ. The look of the defined rotation coordinate system is shown in FIG. 2A and FIG. 2B. Using these three unit vectors of eₙ, eᵥ, eᵣ the vector components of ΔHᵢ in the equation 2 can be expressed as the direction cosine of a, b, c against eᵥ, eₙ, eᵣ respectively shown in the equation 7.

If αᵢ=αᵢ₋₁, c becomes zero (c=0), but in the case that if not so (αᵢ≠αᵢ₋₁), c is not equal to zero (c≠0), and the rotation axis vector nᵢ tilts toward the magnetic field vector Hᵢ (or h) from the rotation vector nᵢ₋₁ by the difference angle Δαᵢ between both rotation axis vectors of nᵢ and nᵢ₋₁. The angle Δαᵢ is defined as the equation 8A so that the new momentary three axis rectangular coordinate system as shown in the equation 8B is revised using the equation 8 and three unit vectors of eₙ, eᵥ, eᵣ as shown in the equation 6 (referred in FIG. 2C). AS the result, the difference vector ΔHᵢ is expressed as the equation 8C and the radius vector Hr is defined as the equation 8D for the reason that the absolute value of the radius vector Hr is equal to |Hr|(=O*H) and the unit vector is equal to the unit vector eᵣ′. The outer product is calculated by substituting Hr and ΔHᵢ to the equation 2. The angular velocity vector is obtained as the equation 9A which is modified from the equation 2 because eᵣ×eₙ=−eᵥ, eᵣ×eᵥ=eₙ, and eᵣ×eᵣ=0 in condition of the right handed coordinate system. By normalizing the angular velocity vector ωᵢ the angular axis vector nᵢ shown in equation 9B is obtained (In this manner, the step to calculate the rotation axis vector is decided.).

The angular velocity vector is calculated as ωₜₕ=(|ωₚᵣ|/sin αᵢ)·nᵢ shown in the equation 10 using the rotation axis vector nᵢ and the absolute value |ωₚᵣ| of the angular velocity vector described above (In this manner, the step to calculate the real angular velocity vector is decided.).

It should be noted that nᵢ is made feedback as the base unit vector needed for calculation of nᵢ₊₁ in reference to the equation 6. The initial value nᵢ is given as the value when the stationary state moves to the rotational mode or some rotational mode shifts to anther rotational mode. It is calculated by the outer product of ΔH₀ and ΔH₁ referred in the equation 1A. In addition it can be calculated by the deference angle of the three dimensional directions which is completed using combination with the accelerometer and magnetometer under the stationary state. Even if small errors cause just after stationary axis rotational mode changes to the free axis rotational mode, the error is convergent to the correct rotation axis vector nᵢ by the very small time by repeating the calculation described above.

In this connection, the coefficients of a, b and c used in the equation 7 are given as the cosines calculated by the inner product of the difference vector ΔHᵢ and the three unit vector of eₙ, eᵥ and eᵣ respectively which are a=ΔHᵢ·eᵥ, b=ΔHᵢ·eₙ, c=ΔHᵢ·eᵣ.

### <Judgement on the Rotational Mode>

### (1) Basic Concept to Judge

It is possible to judge the rotational mode which has the stationary-axis motion or the free axis motion if using the mode judging parameter J calculated by the equation 11 which is formed with the rotation axis vector n_{Δ} and the difference magnetic vector ΔHᵢ obtained by calculation using the equations of 1A and 1B mentioned above. This J value is the cosine of the angel γ between n_{Δ} and ΔHᵢ with the range of from 0 to 1.

When the J value takes around 0, γ becomes around 90° which means the rotation of the moving body takes the stationary axis rotational mode to make stable rotation around a stationary-axis vector and the axis rotation vector n continue to take n_{Δ}. (In this manner, the step to calculate the rotation axis vector is decided.) rotation axis. The real angular velocity vector ωₜₕ rotating with the constant rotation axis mode is calculated by the equation 5 (In this manner, the step to calculate the real angular velocity vector is decided.).

On the contrary, when the J value takes over the designated threshold value, the rotation of the moving body rotation axis becomes the free axis rotational mode and the rotation axis vector n takes successive change by the momentary rotation axis vector nᵢ calculated by the both equations of 8A or 9A. The true angular velocity vector ωₜₕ under this mode can be calculated the equation 10 (In this manner, the step to calculate the true rotation axis vector is decided).

Therefore it is favorably that the step to calculate the rotation axis relating to the present invention includes the mode judging step which judge the rotation with the stationary axis rotational mode or the free axis rotational mode.

Moreover it is favorably that the step to calculate the rotation axis relating to the present invention regards the rotation axis vector n_{Δ} as the rotation axis vector n when the mode is judged as the stationary axis rotational mode and regards the rotation axis vector nᵢ calculated successively as the rotation axis vector n when the mode is judged as the free axis rotational mode.

### (2) Decision to Take Waiting

In the case that the moving body starts to move from the stationary state, makes rapid change in rotation even though rotating under the stationary axis rotational mode, or shifts the rotation axis vector to be more stable from rotating under the free axis rotational mode, it is possible there are some cases that the J value calculated by the equation 11 leads miss judgement. For example, in the case that the rotation radius in the magnetic field vector system decreases rapidly even though rotating under rotation with the constant rotation axis mode, the rotation axis vector n_{Δ} calculated by the equations of 1A or 1B might become smaller and take big errors. As the result, though the constant rotation axis mode is kept actually, the J value gives judgement that it is the free axis rotational mode. However considering the angular momentum conservation powered to the moving body under rotation, the exchange between the stationary axis rotational mode and the free axis rotational mode is difficult to happen repeatedly during small time so that it is temporary or in transition that the judgement based on the J value may become not stable.

In the step to decide the rotation axis vector relating to the present invention, it is favorable that the judgement is carried out in the case the J value takes to continue within designated value during the designated period. In other words, it is favorable that the step to decide the rotation axis vector relating to the present invention has the waiting decision step which gives the decision to change the rotational mode when the J value keep to take within the designated value during the designated period in addition to the deciding mode step which is carried out based on the J value to decide the mode calculated by the rotation axis vector n_{Δ} which is derived from the primary difference vector and the outer product ΔHᵢ₋₁×ΔHᵢ of the primary difference vector ΔHᵢ and the secondary difference vector ΔHᵢ₋₁.

### (3) Judgment to Freeze the Mode Change

The present inventions carry out the successive calculation on the rotary information by obtaining the deference of three dimensional vector components of the magnetic field vectors per the very small time which are given by continuous measurement of the base magnetic field vector using the magnetometer fixed on the moving body. When the rotation axis vector moves close to the axis vector of the standard magnetic field vector (called as the base axis or the specific axis as bellow, where in the case the magnetic vector is the earth magnetism, the axis of the earth magnetic field is regarded as the base axis) the difference vector of the magnetic field vector to be measured becomes small comparatively so that the calculation of the rotation axis vector is apt to make big error. However when the moving body rotates with the stationary-axis mode, rotation axis the peculiar area apt to cause these big error takes no more than a few % area in total spherical surface. When the moving body rotates with the free axis rotational mode, the rotation axis vector takes just small probability because even if the rotation axis vector exist in the peculiar area, it must pass through the peculiar area after a very small time in almost cases.

Therefore to make stable calculation on the rotary information of the moving body, when the angle δ between the calculated rotation axis vector and the base axis (the standard magnetic field vector Hs) takes within the designated value, it is favorable to freeze the change of the rotational mode and the rotation axis vector. That is, it is favorable the step to decide the rotation axis vector including the step to decide the rotational mode has the step to judge freezing the mode change when the adjacent index between the standard magnetic field vector Hs and the rotation axis vector takes within the primary designed value. The step to judge freezing the mode change becomes more favorable by freezing the rotation axis vector when the adjacent index takes within the secondary designed value included in the primary designed value. In addition, the adjacent index is given as the calculation value such as the angle δ mentioned above or the cosine of the rotation axis vector and the magnetic field vector.

The proper range of the peculiar area to freeze these rotational mode should be set according to the performance of the magnetometer. For example it is favorable to freeze the change mode when the adjacent index δ takes the primary range of δ<10° to 20° and to freeze the change of the rotation axis vector with keeping the rotation axis vector before calculated when it takes the secondary range of δ<6° to 10°.

### <The Orbit Axis Rotational Mode>

(1) The inventor has made further study and found that the orbit axis rotational mode besides the stationary axis rotational mode and the free-axis rotational mode mentioned above exists to rotate around the almost stable orbit axis keeping the specific attitude with the change of the rotation axis vector.

The end point N (n_{y}, n_{y}, n_{z}) of the rotation axis vector (n) moves on the spherical surface with the unit radius centered at the origin in three axis orthogonal coordinate of the rotation axis vector system distinguished from the magnetic field vector system. The end point takes the special trajectory dependent on the rotational mode. The trajectory for the orbit axis rotational mode was different from those of the stationary axis rotational mode and the free axis rotational mode. In concrete terms, the trajectory of the stationary axis rotational mode shows one point on the spherical surface of the rotation axis vector n, the free axis rotational mode shows the arbitrary curved lines and the orbit axis rotational mode shows the circle or ellipsoidal lines respectively.

This orbit axis rotational mode causes in order to restrain the rotation of the moving body around the specified orbit axis suppressing free motion. Therefore the calculation based on the free-axis rotational mode mentioned above cannot always offer the exact rotary information rotating the moving body under the free-axis rotational mode. However the orbit axis rotational mode is a special mode including within the free-axis rotational mode so that the rotation axis vector can be calculated by modifying the rotation axis vector (nᵢ) obtained from the free-axis rotational mode to the proper rotation axis vector (nᵢ′). The calculation algorism for the free-axis rotational mode is applied to that of the orbit axis rotational mode by substituting nᵢ′ for nᵢ. The modification method to calculate nᵢ′ is described as bellow in concrete terms.

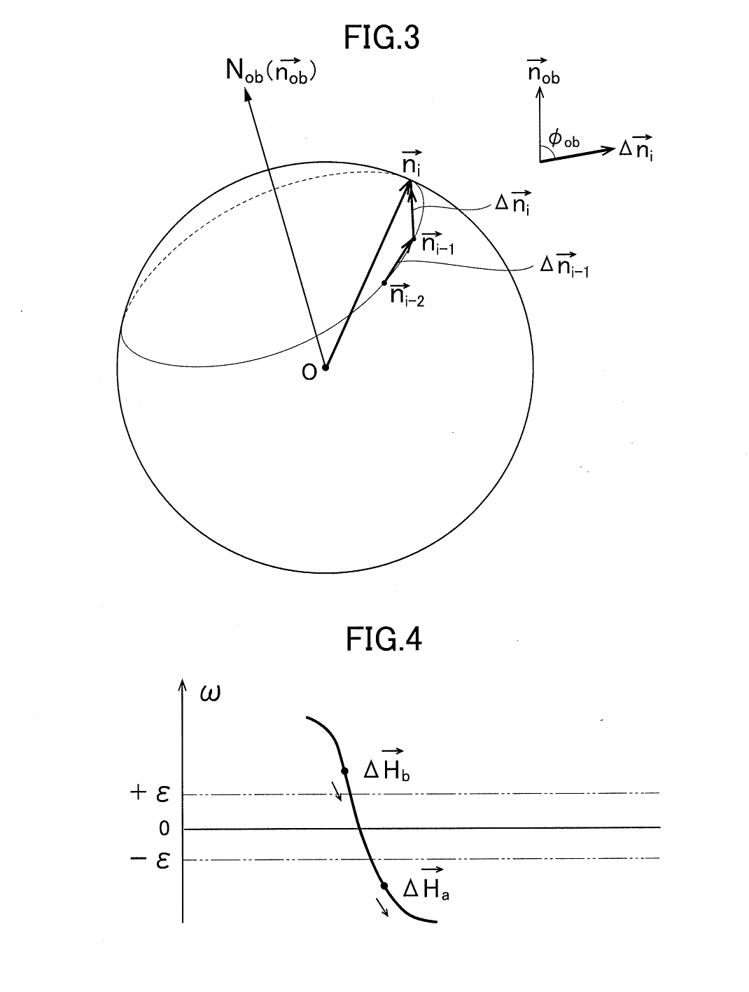

(2) The orbit axis vector (n_{ob}) normalized along the orbit axis (N_{ob}) is calculated by the equation 21A formed by the outer product of two differential magnetic vectors (Δnᵢ and Δnᵢ₋₁) derived from three rotation axis vector (nᵢ, nᵢ₋₁, nᵢ₋₂) at the momentary time of (i)th, (i−1)th and (i−2)th seeing from FIG. 3. The angle (φ_{ob}) between the orbit axis vector and the axis difference vector (Δnᵢ) is calculated by the equation 21B as the angle index of sine value or cosine value (cos φ_{ob}, sin φ_{ob}). The rotation axis vector (nᵢ′) is derived from the equation 22 and is applied to be substituted for the rotation axis vector (nᵢ). Continuing to rotate with the orbit axis rotational mode, next rotation axis vector nᵢ₊₁ (as a temporary one) can be calculated by the calculation method for the free-axis rotational mode using the (i)th rotation axis vector (nᵢ) and substitutes into the equation 21A to get n₁₊₁′. Again this nᵢ₊₁′ is regarded as the (i)th rotation axis vector (nᵢ). These operations are repeated as long as the orbit axis mode continues.
(3) In addition, the judgment on the rotational mode which is the orbit axis rotational mode or not can be made by which within or not the designated value of the orbit index (K) calculated by the equation 23 including both of the orbit axis vector (n_{ob}) and the axis difference vector (Δnᵢ).

Based on the above discussion, the step to decide the rotation axis vector relating to the present invention is favorable to have both steps to decide the orbit axis vector and to modify the rotation axis vector when the rotation of the moving body rotates under changing the rotation axis and rotating around a special orbit axis to keep the special attitude. The step to decide the orbit axis vector carries out the calculation on the orbit axis vector (n_{ob}) using the outer product (Δnᵢ₋₁×Δnᵢ) of the primary axis difference vectors (Δnᵢ=nᵢ−nᵢ₋₁) and the secondary one (Δnᵢ₋₁=nᵢ₋₁−nᵢ₋₂) derived from three rotation axis vectors (nᵢ, nᵢ₋₁, nᵢ₋₂) at three momentary time of (i)th, (i−1)th and (i−2)th (tᵢ, tᵢ₋₁, tᵢ₋₂). On the other hand, the step to modify the rotation axis vector obtains t the revised rotation axis vector (nᵢ′) reviving the rotation axis vector (nᵢ) derived from the calculation method for the free-axis rotational mode and it is regarded as the momentary rotation axis vector (nᵢ).

Therefore the step to decide the kinds of rotational mode relating the present invention is favorable to include the judgment on the orbit axis rotational mode using the above mentioned the orbit index (K) etc. besides the judgment for the stationary axis rotational mode or the free-axis rotational mode. Thus, according to the judgment result, choosing the rotational mode (continuation or changing) calculated the rotation axis vector (n) is preferred.

### <Reversal Mode>

(1) The present invention is formed on the assumption that the rotation of the moving body cannot take the rapid change due to the law of the angular momentum conservation and obtains the exact rotary information by the proper sequential computation. However some artificial means or operation can cause the rapid change or the rotation situation or abnormal rotation. For example, it is possible to reverse the orientation of the rotation axis or to vibrate it by repeating the reversal motion. It is noted that the reversal mode includes the vibration motion in the present description.

When the reversal motion is carried out, the orientation of the rotation axis vector (nᵢ) makes reverse rapidly as exchange of plus and minus. It is concern that just only sequential computation which cannot follow up the rapid change cannot give exact result of the rotary information of the moving body at the moment. On judging which the rotation makes reversal or not, when it takes the reversal mode, the reverse rotation axis vector (−nᵢ) given by reversing the sign of the rotation axis vector (nᵢ) calculated before the mode will change to the reversal mode is regarded as the new rotation axis vector (nᵢ). In this way, the rotation axis vector can be calculated exactly following up the vibration repeating the above operation,

(2) The judgment on the reversal mode is carried out as following. The moving body rotates continuously so that the angular velocity (ω) of the moving body (in concrete terms, the real (ωₜₕ) or virtual angular velocity vector (ωₚᵣ)) takes the absolute value of zero at the points to change the angular velocity around the rotation axis from plus to minus or from minus to plus (reverse point). Before and after the absolute value becomes zero, difference vector (ΔHᵢ=Hᵢ−Hᵢ₋₁) of two magnetic field vector (Hᵢ) are decided as a before difference vector (ΔHb) going to zero (or decreasing |ω|) and an after difference vector (ΔHa) going away from zero (or increasing |ω|).

These both difference vectors are normalized to unit vectors of Δha=ΔHa/|ΔHa| and Δhb=ΔHb/|ΔHb|, and the inner product (P=Δhb·Δha) of both unit vectors is calculated. When the inner product value takes minus, it can be judged to make reversal motion as for the rotation of the moving body. On the contrary, when it takes plus which means both vectors have same orientation, it can be judged not to make reversal motion at the point where the absolute value becomes zero. In addition, the reversal index value P may be calculated by the equation 24. When using this calculation, the value P shows −1 on reversal judgement and +1 on no reversal judgment so that this calculation is easily put into the calculation algorism of the present invention which means the step to decide the rotation axis vector.

Moreover at the very close point when |ω| becomes 0, the sign of the difference vector shows vibration during very small time resulting to make miss judgment on the reversal mode. Therefore a before difference vector (ΔHb) and an after difference vector (ΔHa) at just before and after time excluding the point when |ω| becomes nearly 0, that is, within −ε<|ω|<+ε here ε means very small value, are held up or memorized to adopt them as ΔHb and ΔHa mentioned above as shown in FIG. 4.

It is favorable that the step to decide the rotation axis vector relating to the present invention includes the step to decide the reversal rotation axis which the reversal rotation axis vector (−nᵢ) revered by the rotation axis vector (nᵢ) is adopted as the renewed rotation axis vector (nᵢ) when the signs of the before difference vector (ΔHb) and the after difference vector (ΔHa) show reversal in orientation just before and after the time when the real (ωₜₕ) or virtual angular velocity (ωₚᵣ) becomes zero. The step to decide rotational modes is favorable to carry out the judging the reversal mode in parallel to other modes mentioned above. In addition, the word of the reversal expressed in the present invention means both difference vectors are going to reversal orientation actually and the angle between both the vectors is not needed to take just 180°. In other words, it is allowed that it takes the obtuse angle as seeing from the judgment method to use the reverse index P mentioned above.

### <Initial Value>

The initial value n₀ of the rotation axis vector nᵢ as well as the calculation method is important to obtain the exact rotary information of the moving body especially as the angular velocity vector at momentary time with good followability. When the moving body continue under rotation, the serious trouble does not occur for the reason the existing initial value is succeeded to next rotational mode even though the rotational mode changes.

However when the rotation starts from the stationary state or quasi-stationary state having the angular velocity of zero or nearly zero respectively to the rotational state, for starting or restarting the calculation without the inheritance initial value, it is needed to calculate the proper initial value by using some kind of method to obtain the exact momentary calculation result.

### (1) Transitional Period

The conventional mobile devices has both of a magnetometer which can measure three dimensional magnetic field vector such as the earth magnetism and an accelerometer which can measure three dimensional acceleration such as the gravity vector and equips the calculation program to obtain three dimensional directions or the own attitude using 6 vector components data measured by these sensors. This system is called appropriately as the attitude gyroscope in the description.

The 3 dimensional direction calculation program is carried out to offer the attitude of the mobile devices at any momentary time. The three angle components (θ, η, φ) of the rotation axis direction is determined by the angle between the coordinate unit vector in the orthogonal coordinate. These differential value which is obtained by dividing these deference angles of Δθ, Δη, Δφ by the small time (Δt) gives the angular velocity vector including the rotation axis vector at any momentary time and the rotation axis vector. The angular velocity vector or the rotation axis vector (n₀) obtained by the above mentioned manner is substitute for the initial value. If so, the calculation must be carried out to give the exact result with good followability showing no delay even from the transitional period when the stationary state including quasi-stationary state shifts to the rotational state.

The attitude gyroscope calculates the attitude of the mobile devices using the gravity acceleration with the direction and the absolute value becoming stable measured by the accelerometer and the earth magnetism measured by magnetometer. However the accelerometer measure the motion acceleration as well as the gravity. When the mobile devices start to rotate rapidly from stationary state to the rotational state, the initial value of the angular velocity vector does not always become precise or high accuracy due to addition of the big motion acceleration. That is, the motion acceleration becomes larger, the error on the rotation axis vector obtained by the attitude gyroscope becomes larger. It is noted that the motion acceleration (Gₘ) is the sum with the centrifugal force (rω²) and rotation acceleration (ra/a means angular acceleration, r means radius of rotation). The acceleration (G) measured by the accelerometer is the sum of the gravity force (G₀) and the motion acceleration (Gₘ).

On the other hand, when the moving body starts to rotate from the stationary state with rapid speed, adequate magnetic difference vectors can be obtained at the starting point of the rotation. In the case that two adequate vectors of ΔH₀ and ΔH₁ can be obtained, the exact rotation axis vector n_{Δ0} at the starting period can be calculated by the equation of 1A and 1B. By substituting this value n_{Δ0} for the initial rotation axis vector n₁ of the free-axis rotational mode, the exact rotation axis vector after the initial moment can be calculated consequent to the calculation method of the free-axis rotational mode. It is noted that which initial values of n₀ and n_{Δ0} is better as the initial value is dependent on the magnitude of the motion acceleration (Gₘ=ra+rω²) or the index compared to the designated threshold value.

When the magnetic difference vector (ΔH) during a small time (Δt) takes within the designated small value under transitional period shifting from the stationary state or the quasi-stationary state to the rotational state (at least when the motion acceleration becomes over the designated value), it is favorable that the step to decide the rotation axis vector relating to the present invention includes the step to decide the initial value (n₁) which is given by the quasi-stationary rotation axis vector (nₛ₀) calculated using two three dimensional direction vectors at the primary time (tᵢ) and the secondary time (tᵢ₋₁), which are derived from the three dimensional direction calculation program using three dimensional measurement value of the standard magnetic field vector and the acceleration.

Moreover, when the motion acceleration of the moving body mentioned above takes at least over the designated value and the magnetic difference vector (ΔH) during a small time (Δt) takes within the designated small value, it is favorable this step to decide the initial value (n₁) includes the step to decide the initial value (n₁) which is given by the rotation axis vector (n_{Δ0}) calculated using the outer product (ΔHᵢ₋₁×ΔHᵢ) of the primary magnetic difference vector (ΔHᵢ) and the secondary magnetic difference vector (ΔHᵢ₋₁).

### (2) Horizontal Rotation Under Peculiar Surroundings

As described above, the rotation axis vector approaches to the standard magnetic field vector, the magnetic difference vector becomes small. Thus peculiar cases happen when the horizontal rotation is carried out inside the reinforced concrete building having reinforcing bars extending to vertical direction or around the pole of the earth besides the rotation axis approaches temporarily or momentarily to the magnetic field vector.

When the moving body makes the approximate horizontal rotation under peculiar surroundings described above, the rotation axis vector (n₀ or nₛ₀) calculated by the attitude gyroscope mentioned above or the rotation axis vector (n_{Δ0}) calculated by the outer product (ΔH₀×ΔH₁) of two magnetic difference vectors become not always suitable initial value because the vector components (noise component) besides the vertical vector component of the rotation axis vector is apt to be big. In this case, the exact rotation axis vector can be obtained from the initial period of the rotation by the calculation based on the assumption that it starts to rotate with the stationary axis rotational mode having the rotation axis of the vertical axis.

Furthermore, the gravity acceleration is not influenced from peculiar surroundings. The Judgement on which the rotation is going under peculiar surroundings or not can be made by the angle (ζ) between the magnetic field vector measured by the magnetometer and the gravity vector measured by the accelerometer or the index value within the designated value such as ζ<20°. The judgement on which the horizontal rotation is made or not can be carried out by the inner product shown in the equation 25 of the motion acceleration vector (Gₘ) and the gravity vector (G) as the index Q within the designated value of near zero. When the moving body rotates perfectly to keep horizontal rotation, the value Q becomes zero (Q=0) because the motion acceleration (Gₘ) includes just only the centrifugal acceleration (rω²).

By the way, the approximate horizontal rotation of the moving body is made quite often no matter when it exist under peculiar surroundings. When the index Q for the horizontal motion shows the approximate horizontal rotation, it is allowed the calculation based on the stationary axis rotational mode is carried out automatically regarding the vertical axis as the rotation axis.

Therefore when the stationary state including quasi-stationary state shifts to the rotational state, this step to decide the initial value (n₁) is favorable to include the step to decide the initial value (n₁) of the horizontal rotation which is given as the gravity vector n_{g} in the case that the angle between the motion acceleration vector and the gravity vector or the index takes within the designated value.

### <<Magnetometer>>

The magnetometer relating to the present invention is necessary to detect the three vector components of the magnetic field vector on measuring the standard magnetic field vector such as the earth magnetism but the kinds of the magnetic sensor is not concerned. For example, Magneto impedance sensor, hall sensor, magneto resistance sensor and so on is applicable as the magnetometer. The Magneto impedance sensor is most preferable because of excellent performance in responsiveness, sensitivity, accuracy and any properties as well as achievement on small size.

MI sensor is formed by the MI element which consists of the magnetosensitive material made from the amorphous wire and a pick up coil surrounding the wire. MI sensor works based on the MI effect that the impedance of the wire changes according to the external magnetic field when the high frequency current passes through the wire. The external magnetic field is measured using the coil voltage related to the change of the wire impedance. There are a lot of applications on MI sensors. The patents of WO 2005/19851 and WO 2009/119081 describe the detail of the MI technology.

In addition, one MI element is needed to measure each detected direction so that in the case to detect the magnetic field vector in three axis rectangular coordinates system, three MI elements are needed to make aliment along X axis direction, Y axis direction and Z axis direction respectively. However the patent of WO 2005/19851 reported a type of two MI elements omitting one element can detect three axis direction elements of the magnetic field vector.

### <<Moving Body>>

(1) The moving body rerating to the present invention are objects such as measuring modules, measuring devices, some kinds of electronics device equipping the magnetic gyroscope of the present invention. The conventional 3 axis gyroscope must be omitted by using the magnetic gyroscope of the present invention. Therefore the electronics devises requesting to make small size such as mobile phone, smart phone, tablet, car navigation, digital camera and so on is suitable to be regarded as the moving body using the present invention. By the way, the digital camera which use the rotary information for correction against camera shake can be regarded as the moving body using the present invention.

In addition, it is favorable the moving body of the present invention can provide the calculation program to calculate the attitude or direction using the data measured by a magnetometer, and an accelerometer. The moving body of the present invention is needed to equip the magnetic gyroscope but it can provide the current gyroscope and the attitude gyroscope jointly with the magnetic gyroscope.

(2) The proper three dimensional direction values according to the motion situation are needed to grasp the rotation axis vector precisely used for calculation of the attitude and rotary information of the moving body. It is favorable the moving body of the present invention has the method to determine the attitude and three dimensional directions of the moving body according to the rotation situation using the three dimensional directions calculated by the magnetic gyroscope and the three dimensional directions calculated by the attitude gyroscope. The details are explained as follows.

The three dimensional direction values derived from the integration of the momentary angular velocity obtained by the calculation method or magnetic gyroscope takes the increasing error proportional to the duration time of continuous rotation with small angular velocity. On the other hand, the three dimensional direction values calculated by the attitude gyroscope is made high exact result when the angular velocity is small under the quasi-stationary state or the stationary state.

It is suitable when the moving body keeps to be stationary or quasi-stationary the 3 dimensional attitude value adopts the calculation value (the primary direction value D_{c}) calculated by the attitude gyroscope, on the other hand, when it rotates with high angular velocity, 3 dimensional attitude value adopts the calculation value (the secondary direction value Dⱼ) calculated by the magnetic gyroscope. When the moving body rotates under the immediate state between stationary or quasi-stationary state and rotation with high angular velocity, it is suitable that the proper direction value (Dₐᵥ) averaging with the any gyroscope output (D_{c}, Dⱼ) is adopted as the three dimensional directions considering the angular velocity (ω) or the motion accelerometer (GₘG−Gₘ). The momentary three dimensional directions of the moving body can be calculated exactly according to the rotation situation from the stationary state to the rotation with high angular velocity.

When the moving body takes the stationary state or quasi-stationary state, the motion acceleration and the angular velocity becomes small. When taking high angular velocity, the motion acceleration and angular velocity becomes large. Therefore by considering the motion acceleration and the angular velocity, the rotation situation of the moving body can be understood exactly.

It is favorable the moving body of the present invention equips the magnetic gyroscope and the attitude gyroscope calculated by the output of the magnetometer and the accelerometer and at the same time, it equips the method to determine proper three dimensional directions according to the rotation situation using the primary three dimensional directions (D_{c}) which is calculated by the attitude gyroscope, the secondary one (Dⱼ) which is calculated by the magnetic gyroscope, and the weighting factor (A, B) calculated by both of angular velocity parameter (R_{ω}) obtained from the angular velocity and the motion acceleration parameter (R_{g}) obtained from the motion acceleration.

These proper direction values (Dₐᵥ) is obtained by the equations of 31, 32A, 32B, 33A and 33B as one example. The parameters of α_{ω} and α_{g} in the equations of 33A and 33B give the transition range expressing the medium range and the connecting range based on the angular velocity and the motion acceleration respectively. And the parameters of β_{ω} and β_{g} in the equations of 33A and 33B give the stationary or quasi-stationary range expressing range based on the angular velocity and the motion acceleration respectively. For example, it is recommended that βω=24 dps (degree per second), α_{g}=18 mg (gravity G₀=1000 mg), β_{ω})=60 dps, and β_{g}=20 mg.

### EXAMPLES

### Flow Chart

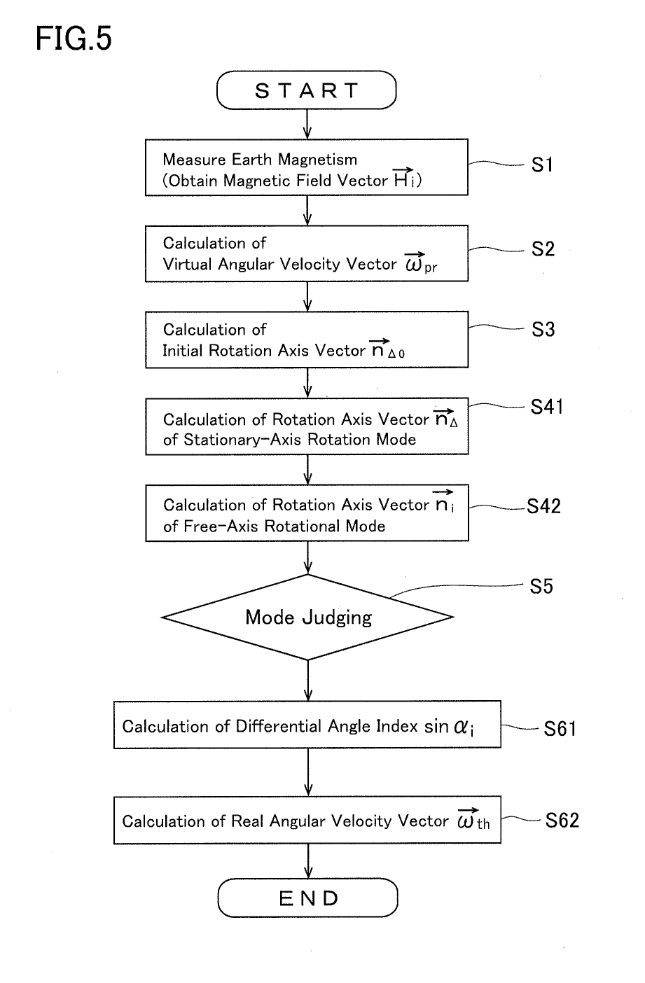

The flow chart as one embodiment rerating to the calculation method requiring a rotary information of the present invention is shown in FIG. 5. First of all, in the step S1 the standard magnetic field vector such as the earth magnetism is measured by 3 dimensional magnetometer per every micro time Δt. The magnetic field vector consisting of three vector components in the three axis rectangular coordinate is obtained sequentially time by time. These data is held into the memory equipped on the mobile information devices called as the step to obtain the magnetic field vector.

Next in the step S2, the virtual angular velocity vector is calculated by the equation 3 mentioned above using the magnetic field vector Hᵢ measured at the ith time determined as tᵢ=t₀+Δt·i and the magnetic field vector Hᵢ₋₁ measured at the (i−1)th time called as the step to calculate the virtual angular velocity vector.

In the step S3, the initial rotation axis vector (n_{Δ0}) is decided which if necessary can use properly the attitude gyroscope or the gravity vector according to the rotation situation or surroundings of the moving body.

In the step S41, the rotation axis vector n_{Δ} according to the stationary axis rotational mode is calculated by the equations of 1A and 1B mentioned above using the three magnetic field vectors obtained in the step S1 called as the step to decide the rotation axis vector. In addition, it is allowed it can be given as the value averaged with multi measured values.

In the step S42, the rotation axis vector nᵢ according to the free-axis rotational mode is calculated by the equations of from 6 to 9B mentioned above called as the step to decide the rotation free axis vector. These steps of S41 and S42 means are the step to decide the rotation axis vector for the present invention.

In the step S5, judging parameter J is calculated by the equation 11 mentioned above using the magnetic difference vector ΔHᵢ between the magnetic field vector Hᵢ at the ith time and the magnetic field vector Hᵢ₋₁ at the (i−1) th time and the rotation axis vector n_{Δ} calculated previously. When J value is smaller than the designated vale f, the rotation of the moving body takes the stationary axis rotational mode and when over f value, it takes the free-axis rotational mode called as the step to decide the rotational mode. However when the parameter K calculated by the equation 23 is approximately zero or within the designated value, the rotation of the moving body is decided to be the orbit axis rotational mode and the orbit axis vector n_{ob} is calculated by the equation 21A using the axis difference vector (Δnᵢ₋₁, Δnᵢ) obtained by three rotation axis vectors (nᵢ, nᵢ₋₁, nᵢ₋₂) calculated in the step S42.

In the step S61, according to the result given by the step S5 the angle αᵢ or the angle index sin αᵢ is calculated by the equation of 4 or 5 called as the step to calculate the angle between the rotation axis vector and the magnetic field vector. In the step S62, according to the result given by the step S5 the real angular velocity vector ωₜₕ at the ith time tᵢ (t=t₀+Δt·i) is calculated by the equation of 5 or 10 called as the step to decide the real angular velocity vector.

Repeating the calculation mentioned above, the angular velocity or the rotary information of the moving body at any time can calculated actually without delay against the change of the attitude.

### <<Experiment>>

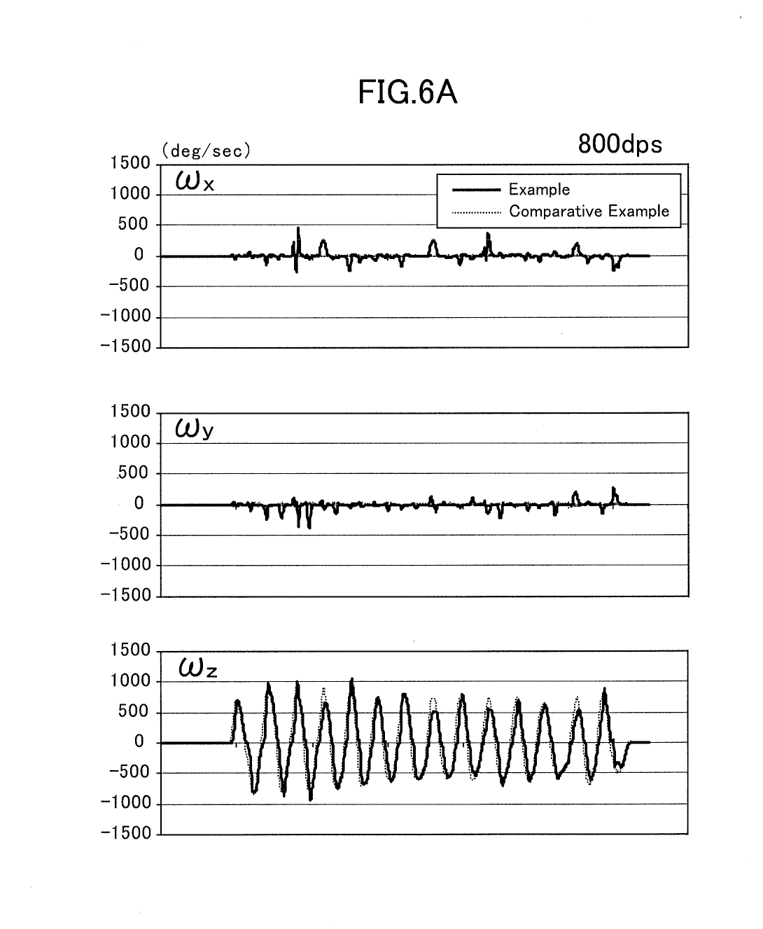

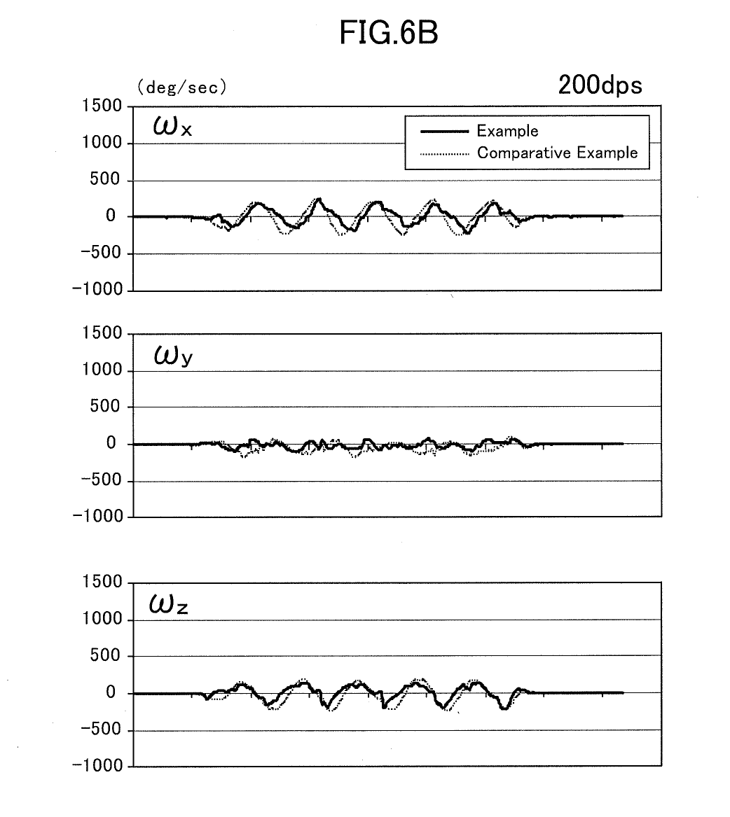

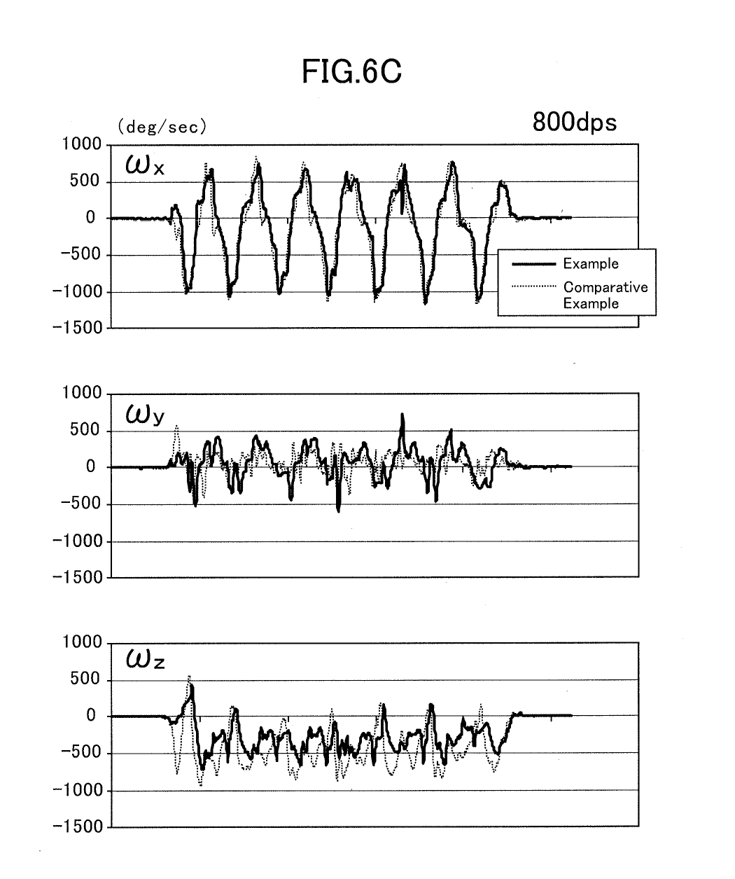

The experimental result to measure the angular velocity vector of the moving body using the magnetic gyroscope and the current vibration type gyroscope such as MEMS gyroscope and the calculation program on the rotational information which can carry out the flow chart mentioned above is shown in Figures of 6A, 6B and 6C. FIG. 6A shows the stationary axis rotational mode where Z axis is the rotation axis, FIG. 6B shows the orbit axis rotational mode where the rotation axis change on the two dimensional plane and FIG. 6C shows the free axis rotational mode where the rotation axis change in the three dimensional space. The results measured by the magnetic gyroscope are nearly equal to the results measured by the vibration type gyroscope under any rotational mode. In addition, there is small difference on Z component (ω_{z}) shown in FIG. 6C rotating with the free axis rotational mode. The reason is probably the influence of the origin drift caused by MEMS gyroscope.

By the way, the experiments were carried out using the magnetometer of AMI306 produced by Aichi Steel Corporation and the MEMS gyroscope of MPU3050 produced by Invensense Corporation with the interval of 8 ms (=Δt). Figures of 6A and 6C show the result carried out under the angular velocity of 800 dps (degree per sec) and FIG. 6B shows under that of 200 dps (degree per sec).

$$\begin{matrix}{\vec{ω}}_{Δ} = \frac{Δ \vec{{H}_{2}} \times Δ \vec{{H}_{3}}}{\vert Δ \vec{{H}_{2}} \vert \cdot \vert Δ \vec{{H}_{3}} \vert} \cdot \frac{1}{Δ t} & ( The Equation 1 A ) \\ \vec{{n}_{Δ}} = \frac{\vec{{ω}_{Δ}}}{\vert \vec{{ω}_{Δ}} \vert} & ( The Equation 1 B ) \\ {{ω}^{->}}_{th} = \vert {{ω}^{->}}_{th} \vert \cdot {n}^{->} = \frac{\vec{{H}_{r}} \times Δ \vec{{H}_{i}}}{{\vert \vec{{H}_{r}} \vert}^{2}} \cdot \frac{1}{Δ t} & ( The Equation 2 ) \\ {{ω}^{->}}_{pr} = \frac{\vec{{H}_{i}} \times Δ \vec{{H}_{i}}}{{\vert \vec{{H}_{i}} \vert}^{2}} \cdot \frac{1}{Δ t} \\ ( i = 1 , 2 , … ) & ( The Equation 3 ) \\ \begin{matrix}\vert {{ω}^{->}}_{th} \vert = \vert {\vec{ω}}_{Δ} \vert = \frac{\vert \vec{{ω}_{pr}} \vert}{\vert sin {α}_{i} \vert} \\ \vert sin {α}_{i} \vert = \sqrt{1 - {cos}^{2} {α}_{i}} = \sqrt{1 + {( \vec{h} \cdot \vec{{n}_{Δ}} )}^{2}} \\ \vec{h} = \frac{\vec{{H}_{i}}}{\vert \vec{{H}_{i}} \vert}\end{matrix} \} & ( The Equation 4 ) \\ {{ω}^{->}}_{th} = \vert {{ω}^{->}}_{th} \vert \cdot \vec{{n}_{Δ}} = \frac{\vert \vec{{ω}_{pr}} \vert}{\vert sin {α}_{i} \vert} \cdot \vec{{n}_{Δ}} & ( The Equation 5 ) \\ \begin{matrix}\vec{{e}_{n}} = \vec{{n}_{i - 1}} \\ \vec{{e}_{v}} = \vec{{e}_{n}} \times \vec{{e}_{r}} \\ \vec{{e}_{r}} = \frac{( \vec{h} - \vec{{e}_{n}} cos {α}_{i} )}{sin {α}_{i}} \\ \vert sin {α}_{i} \vert = \sqrt{1 - {cos}^{2} {α}_{i}} = \sqrt{1 - {( \vec{h} \cdot \vec{{e}_{n}} )}^{2}}\end{matrix} \} & ( The Equation 6 ) \\ Δ \vec{{H}_{i}} = a \vec{{e}_{v}} + b \vec{{e}_{n}} + c \vec{{e}_{r}} \\ ( a , b , c \text{:} real coefficient ) & ( The Equation 7 ) \\ \begin{matrix}tan {Δα}_{i} = \frac{c}{b} , cos {Δα}_{i} = \frac{b}{d} , sin {Δα}_{i} = \frac{c}{d} \\ d = \sqrt{{b}^{2} + {c}^{2}}\end{matrix} \} & ( The Equation 8 A ) \\ \begin{matrix}{\vec{{e}_{n}}}^{′} = \vec{{e}_{n}} \cdot cos {Δα}_{i} + \vec{{e}_{r}} \cdot sin {Δα}_{i} \\ {\vec{{e}_{v}}}^{′} = \vec{{e}_{v}} \\ {\vec{{e}_{r}}}^{′} = - \vec{{e}_{n}} \cdot sin {Δα}_{i} + \vec{{e}_{r}} \cdot cos {Δα}_{i}\end{matrix} \} & ( The Equation 8 B ) \\ Δ \vec{{H}_{i}} = a \vec{{e}_{v}} + d {\vec{{e}_{n}}}^{′} & ( The Equation 8 C ) \\ O * \vec{{H}_{i}} = \vec{{H}_{r}} = \vert \vec{{H}_{r}} \vert \cdot {\vec{{e}_{r}}}^{′} & ( The Equation 8 D ) \\ \begin{matrix}\vec{{ω}_{i}} = \frac{\vert \vec{{H}_{r}} \vert {\vec{{e}_{r}}}^{′} \times Δ \vec{{H}_{i}}}{{\vert \vec{{H}_{r}} \vert}^{2}} \cdot \frac{1}{Δ t} \\ = \frac{1}{\vert \vec{{H}_{r}} \vert \cdot Δ t} ( \frac{ab}{d} \vec{{e}_{n}} - d \vec{{e}_{v}} + \frac{a c}{d} \vec{{e}_{r}} )\end{matrix} \} & ( The Equation 9 A ) \\ \vec{{n}_{i}} = \frac{\vec{{ω}_{i}}}{\vert \vec{{ω}_{i}} \vert} & ( The Equation 9 B ) \\ {{ω}^{->}}_{th} = \frac{\vert {{ω}^{->}}_{pr} \vert}{\vert sin {α}_{i} \vert} \cdot \vec{{n}_{i}} & ( The Equation 10 ) \\ J = cos γ = \frac{Δ \vec{{H}_{i}} \cdot \vec{{n}_{Δ}}}{\vert Δ \vec{{H}_{i}} \vert \cdot \vert \vec{{n}_{Δ}} \vert} & ( The Equation 11 ) \\ \vec{{n}_{ob}} = \frac{Δ {{n}^{->}}_{i - 1} \times Δ {{n}^{->}}_{i}}{\vert Δ {{n}^{->}}_{i - 1} \times Δ {{n}^{->}}_{i} \vert} & ( The Equation 21 A ) \\ cos {φ}_{ob} = \vec{{n}_{ob}} \cdot Δ \vec{{n}_{i}} & ( The Equation 21 B ) \\ {\vec{{n}_{i}}}^{′} = {{n}^{->}}_{i - 1} + \{ Δ \vec{{n}_{i}} sin {φ}_{ob} - ( \vec{{n}_{i}} \times Δ \vec{{n}_{i}} ) cos {φ}_{ob} \} & ( The Equation 22 ) \\ K = \vec{{n}_{ob}} \cdot \vec{Δ {n}_{i}} & ( The Equation 23 ) \\ P = \frac{Δ {\vec{H}}_{b} \cdot Δ {\vec{H}}_{a}}{\vert Δ {\vec{H}}_{b} \cdot Δ {\vec{H}}_{a} \vert} = \frac{Δ {\vec{h}}_{b} \cdot Δ {\vec{h}}_{a}}{\vert Δ {\vec{h}}_{b} \cdot Δ {\vec{h}}_{a} \vert} & ( The Equation 24 ) \\ Q = {{G}^{->}}_{0} \cdot {{G}^{->}}_{m} & ( The Equation 25 ) \\ {D}_{av} = A \cdot {D}_{c} + B \cdot {D}_{j} & ( The Equation 31 ) \\ A = {R}_{ω} \cdot {R}_{g} & ( The Equation 32 A ) \\ B = 1 - A & ( The Equation 32 B ) \\ {R}_{ω} = 1 / \{ 1 + {( ω - {β}_{ω} / {α}_{ω} )}^{2} \} & ( The Equation 33 A ) \\ {R}_{g} = 1 / \{ 1 + {( {G}_{m} - {β}_{g} / {α}_{g} )}^{2} \} & ( The Equation 33 B )\end{matrix}$$

1-17. (canceled)

18. A calculation method requiring a rotary information comprising:
a step to measure 3 dimensional vector components of standard magnetic field vector keeping stable in the strength and direction per a very small time continuously;
a step to require an virtual angular velocity vector using the outer product (Hᵢ×ΔHᵢ) with the (i)th magnetic field vector and the difference vector (ΔHᵢ=Hᵢ−Hᵢ₋₁) between the (i)th magnetic field vector (Hᵢ) measured at the (i)th time (tᵢ) and the (i−1)th magnetic field vector (Hᵢ₋₁) at the (i−1)th time (tᵢ₋₁=tᵢ−Δt) before a very small time from the (i)th time;
a step to give the real rotation axis vector (n) at the (i)th time (tᵢ);
the step to calculate a differential angel (αᵢ) between the (i)th magnetic field vector (Hᵢ) and the real rotation axis vector (n) or the differential angle index; and
the step to require the real angular velocity vector (ωₜₕ) using the absolute value of virtual angular velocity vector, the differential angle or the differential angle index and the real rotation axis vector (n),
the step to give the real rotation axis vector (nᵢ), when the moving body is rotating with a free-axis rotational mode to rotate around a changing axis, which is modified by the tilt to the rotation axis vector (nᵢ₋₁) carried out the feedback calculation using three vectors of the (i)th magnetic field vector (Hᵢ), the difference vector (ΔHᵢ=Hᵢ−Hᵢ₋₁) and the moving radius vector (Hr) from rotation origin (O*) to the (i)th magnetic field vector (Hᵢ), where the origin is defined by a rotational coordinate system,
the rotational coordinate system is defined as a momentary coordinate system (eₙ, eᵥ, eᵣ) is calculated by (eₙ) is eₙ=nᵢ₋₁ assuming the rotation axis vector (ni−1) close to the rotation axis (nᵢ), an unit vector (eᵣ) of the moving radius vector (Hr) is calculated by the (i)th magnetic field vector (Hᵢ) and the differential angle (αᵢ), an unit vector (eᵥ) of the travelling direction is calculated by the outer product of (eₙ×eᵣ) the unit vector (eₙ) and the unit vector (eᵣ), wherein
the calculation method requiring a rotary information characterized the real angular velocity vector (ωₜₕ) which is calculated by the virtual angular velocity vector (ωₚᵣ), the rotation axis vector (nᵢ) and the differential angle (αᵢ) or the differential angle index using the equation 10.
ωₜₕ=(|ωₚᵣ|/sin αᵢ)·nᵢ (The equation 10)

19. The calculation method requiring a rotary information according to claim 18, wherein the step to give the real rotation axis vector (nᵢ) is forced to the direction orthogonal to the difference vector (ΔHᵢ) which is calculated by the equations of 9A and 9B using components of a, b, c which are projected the difference vector (ΔHᵢ) in the momentary coordinate system (eₙ, eᵥ, eᵣ).
ωᵢ={(ab/d)eₙ−deᵥ+(ac/d)eᵣ}//|Hr|·Δt (The equation 9A)
nᵢ=ωᵢ/|ωᵢ| (The equation 9B)
Here, d=(b²+c²)^{1/2} (The equation 8A)

20. The calculation method requiring a rotary information according to claim 18, wherein the step to give the real rotation axis vector (nᵢ), when the moving body is rotating with an orbit axis rotational mode to rotate around the stationary-axis keeping a special attitude with the free-axis rotational mode comprising:
a step to conform an orbit axis vector (n_{ob}) using by a outer product (Δnᵢ₋₁×Δnᵢ) where Δnᵢ (Δnᵢ=nᵢ−nᵢ₋₁) and Δnᵢ₋₁ (Δnᵢ₋₁=nᵢ₋₁−nᵢ₋₂) are the difference of the rotation axis vector (nᵢ, nᵢ₋₁, nᵢ₋₂) at the time of (i)th, (i−1)th and (i−2) th (tᵢ, tᵢ₋₁, tᵢ₋₂) respectively;
a step to calculate the orbit angle (ω_{ob}) defined by the angle between the orbit vectors (n_{ob}) and the rotation axis vector (nᵢ) or the orbit angle index; and
a step to modify the rotation axis vector (nᵢ) in order to obtain the revised rotation axis vector (nᵢ′) by revising the rotation axis vector (nᵢ) calculated by the equation 22 using the orbit angle (φ_{ob}) or the orbit angle index for the free-axis rotational mode and the revised rotation axis vector (nᵢ′) is regarded as the momentary rotation axis vector (nᵢ) for the orbit axis rotational mode.
nᵢ′=nᵢ₋₁+{Δnᵢ sin φ_{ob}−(nᵢ×Δnᵢ)cos φ_{ob}}

21. The calculation method requiring a rotary information according to claim 18, wherein the third step to give the real rotation axis vector (nᵢ) at the (i)th time, including the reversed step to obtain the real rotation axis vector (nᵢ) which is given by the reversed rotation axis vector (−nᵢ) defined by reversing the real rotation axis vector (nᵢ) calculated by the above methods before the time when the virtual angular velocity (ωₚᵣ) or the real angular velocity (ωₜₕ) become zero respectively and when both difference vectors of (ΔHa) and (ΔHb) defined by after and before the point have reversed sign.

22. The calculation method requiring a rotary information according to claim 18, wherein the third step to give the real rotation axis vector (nᵢ) at the (i)th time (tᵢ), including the initial step to regard the static rotation axis vector (nₛ₀) before the rotational state calculated by two attitude vector at the time of (i)th (tᵢ) and (i−1)th (tᵢ₋₁) calculated by 3 dimensional direction calculation program using the 3 dimensional magnetic field vector measured by magnetometer and the 3 dimensional gravity vector measured by accelerometer as the initial real rotation axis vector (n₁) when the difference magnetic vector (ΔH) measured during a very small time (Δt) takes within the designated small value.

23. The calculation method requiring a rotary information according to claim 22, wherein the third step to give the real rotation axis vector (nᵢ) at the (i)th time (tᵢ), including the initial step to regard the rotation axis vector (n_{Δ0}) calculated by the outer product (ΔHᵢ₋₁×ΔHᵢ) of two difference vector (ΔHᵢ=Hᵢ−Hᵢ₋₁) at the time of (i)th (tᵢ) and (i−1)th (tᵢ₋₁) as the initial rotation axis vector (n₁) of the real rotation axis vector (nᵢ) when the dynamic acceleration becomes over the threshold value defined and the difference magnetic vector (ΔHᵢ=Hᵢ−Hᵢ₋₁) becomes under a small value defined within a very small time (Δt).

24. The calculation method requiring a rotary information according to claim 18, wherein the third step to give the real rotation axis vector (nᵢ) at the (i)th time, including the initial horizontal rotation step to regard the index vector (n_{g}) based on the gravity vector as the initial rotation axis vector (n₁) rotation axis when the angel between the gravity vector (G) and the dynamic acceleration vector (Gₘ) or the angle index (Q) keeps within the value defined.

25. The calculation method requiring a rotary information according to claim 18, wherein the mode judgement step to select the rotational mode based on the mode judgement parameter (J) defined by the difference vector (ΔHᵢ) and the outer product (ΔHᵢ₋₁×ΔHᵢ) of the difference vector (ΔHᵢ) and the difference vector (ΔHᵢ₋₁=Hᵢ₋₁−Hᵢ₋₂).

26. The calculation method requiring a rotary information according to claim 25, wherein both the mode judgement step and the mode change step to judge the mode change by an interval time defined to keep the mode judgement parameter (J) within a threshold value continuously.

27. The calculation method requiring a rotary information according to claim 25, wherein the mode freezing step to freeze the functionality of the mode change step when taking the gap parameter between the magnetic field vector (Hs) and the rotation axis vector within the primary threshold value.

28. The calculation method requiring a rotary information according to claim 27, wherein the mode judgement freeze step including the rotation axis freeze step to freeze the functionality of the rotation axis change when taking the gap parameter between the magnetic field vector (Hs) and the rotation axis vector within the secondary threshold value included within the primary threshold value.

29. The rotational calculation program which can carry out the calculation method to require a rotary information described in claim 18, by computer and memory the result into memory equipment and communicate with outside computer systems.

30. The magnetic gyroscope to output the rotary information on the attitude change of the moving body comprising:
a magnetometer to measure the three dimensional magnetic field keeping stable in the absolute vale and the direction;
a memory equipment to store the rotational calculation program described in claim 29 and the calculation equipment to carry out the rotational calculation program.

31. The magnetic gyroscope described in claim 30, wherein an accelerometer to measure 3 dimensional acceleration including the gravity acceleration.

32. The mobile device comprising the magnetic gyroscope described in claim 30.

33. The mobile device comprising:
the magnetic gyroscope described in claim 31; and
the attitude gyroscope to calculate the three dimensional directions of the attitude using output of the magnetometer and the accelerometer, wherein
the means to decide the three directions precisely (Dₐᵥ) using the 3 dimensional directions (D_{c}) required by attitude gyroscope, the 3 dimensional directions (Dⱼ) required by the magnetic gyroscope and the weight factor (A and B) calculated by the motion acceleration parameter (R_{g}) required from motion acceleration and the angular velocity parameter (R_{ω}) required from the angular velocity.
